(19) United States
(12) Patent Application Publication
(10) Pub. No.: US 2010/0294249 A1
(43) Pub. Date: Nov. 25, 2010

(54) INSULATOR

(75) Inventors: Shinichi Wada, Saitama (JP); Nobuo Ogura, Saitama (JP)

Correspondence Address: HOLTZ, HOLTZ, GOODMAN & CHICK PC, 220 Fifth Avenue, 16TH Floor, NEW YORK, NY, 10001-7708, US

(73) Assignee: Husqvarna Zenoah Co., Ltd., Kawagoe-shi, Saitama (JP)

(21) Appl. No.: 12/445,924

(22) PCT Filed: Oct. 19, 2006
(86) PCT No.: PCT/JP2006/320839

§ 371 Date: Apr. 16, 2009

(51) Int. Cl. F02M 37/04

(52) U.S. Cl. 123/509

(57) ABSTRACT

An insulator is provided with an acceleration pump attachment on the lower side of an insulating section. An acceleration pump is attached to the acceleration pump attachment. A passage is provided on the lower side of the insulating section. A conduit is provided on a connecting surface which contacts an engine to intercommunicate between an insulator air passage and the passage. A connecting passage is provided on an upper portion of the acceleration pump to intercommunicate between the passage and a negative-pressure introducing chamber. Thus, the acceleration pump can be easily disposed in a space at the lower side of the insulator, which is conventionally a dead space. In addition, an outer pipe to intercommunicate between the insulator and the acceleration pump is not required, whereby space saving can be achieved and a structure of interconnection can be simplified.

### TECHNICAL FIELD

The present invention relates to an insulator used for an engine, and more particularly to an insulator used for a stratified scavenging two-cycle engine.

### BACKGROUND ART

In a two-cycle engine, an exhaust port and a scavenging port are opened and closed by a piston. When the exhaust port is opened by descent of the piston, combustion gas is discharged as exhaust gas. At approximately the same time, the scavenging port is opened from which mixture in a crank chamber is delivered into a cylinder through a scavenging passage. Until the exhaust port is closed by the piston, the delivered mixture scavenges combustion gas remaining in the cylinder while a slight amount of the mixture itself is discharged. Accordingly, a slight amount of unburnt fuel in the mixture is discharged with the exhaust gas. Consequently, fuel efficiency is deteriorated because of fuel loss, and adverse effects may be caused in view of environment preservation. Thus, a complicated muffler structure has been required to separate the unburnt fuel from the exhaust gas and prevent the unburnt fuel from being discharged outside.

In order to solve such a problem, a stratified scavenging two-cycle engine has been suggested. The stratified scavenging two-cycle engine has an air passage communicated with a scavenging passage. Accordingly, air can be supplied to an upper portion of the scavenging passage before scavenging by the mixture. In scavenging, the air is initially delivered into the cylinder and then the mixture is delivered by following the air. Thus, the mixture is not easily delivered into the exhaust port, whereby fuel efficiency is enhanced and a complicated muffler structure is not required.

A commonly available engine including the stratified scavenging two-cycle engine is typically driven with lean mixture during idling. However, when the stratified scavenging two-cycle engine is suddenly accelerated from an idling state, air from the air passage is initially supplied into the cylinder and therefore mixture having a predetermined fuel ratio, which follows the air, is not sufficiently supplied. Consequently, the lean mixture becomes further lean, which causes acceleration failure or engine stop.

In order to solve the above problem, an accelerator for temporarily increasing a fuel amount during acceleration has been suggested (for example, Patent Document 1).

The accelerator as disclosed in Patent Document 1 includes a carburetor, an insulator provided between the carburetor and an engine for reducing heat transmission from the engine, and an acceleration pump connected to the carburetor. An air passage of the insulator and the acceleration pump are communicated with each other via a pipe.

Patent Document 1: JP-A-2001-123841 (Pages 2 to 4)

### DISCLOSURE OF THE INVENTION

### Problems to be Solved by the Invention

However, the acceleration pump is remote from the insulator and the carburetor in the accelerator as disclosed in Patent Document 1. Thus, the acceleration pump requires an installation space that is independent of the insulator and the carburetor. Also, because the acceleration pump and the insulator are communicated via the pipe, this communicating structure may be complicated when the acceleration pump is considerably remote from the insulator and the carburetor.

An object of the invention is to provide an insulator capable of simplifying a communicating structure and achieving space saving in the vicinity of an engine.

### Means for Solving the Problems

An insulator according to an aspect of the invention includes: an insulating section that is provided between an engine and a carburetor and includes an insulator air passage and an insulator mixture passage; and an acceleration pump attachment to which an acceleration pump is attached, the acceleration pump attachment being integrated with the insulating section.

According to the aspect of the invention, since the acceleration pump attachment is integrated with the insulating section, the acceleration pump can be disposed in a space in the vicinity of the insulator, which is conventionally a dead space. Thus, an installation space dedicated for the acceleration pump can be omitted so as to achieve space saving. Further, since the acceleration pump is directly disposed in the vicinity of the insulating section even when a pipe that intercommunicates between the insulator air passage and the negative-pressure introducing chamber is used, the length of the pipe can be short. Thus, a structure of the interconnection can be simplified.

In the insulator according to the aspect of the invention, it is preferable that a conduit for a pressure-introducing passage that intercommunicates between a negative-pressure introducing chamber of the acceleration pump attached to the acceleration pump attachment and an insulator air passage of the insulating section is provided on a connecting surface of the insulating section, the connecting surface being in contact with the engine or the carburetor

According to the aspect of the invention, since the insulator air passage and the negative-pressure introducing chamber are communicated with each other through the pressure-introducing passage provided thereon and the pressure-introducing passage includes the conduit on the connecting surface that connects the engine or the carburetor, a conventional outer pipe can be omitted. Thus, a structure of the interconnection can be further simplified. Incidentally, such a conduit has a tubular shape by being covered with the connecting surface that connects the engine or the carburetor.

### BRIEF DESCRIPTION OF DRAWINGS

FIG. 1 is a cross sectional side view showing a structure in the vicinity of an insulator according to a first exemplary embodiment of the invention.

FIG. 2 is an exploded perspective view showing the insulator.

FIG. 3 is a rear view showing the insulator.

FIG. 4 is a cross sectional side view showing a structure in the vicinity of an insulator, a part of which is omitted, according to a second exemplary embodiment of the invention.

FIG. 5 is a cross sectional side view showing a structure in the vicinity of an insulator, a part of which is omitted, according to a third exemplary embodiment of the invention.

### EXPLANATION OF CODES

1: engine, 20: carburetor, 30: insulator, 31: insulating section, 32: insulator air passage, 33: insulator mixture passage, 41: passage, 42: conduit, 50: acceleration pump, 51: acceleration pump attachment, 61: connecting passage, 80: pressure-introducing passage

### BEST MODE FOR CARRYING OUT THE INVENTION

### First Exemplary Embodiment

A first exemplary embodiment of the invention will be described below with reference to the accompanying drawings.

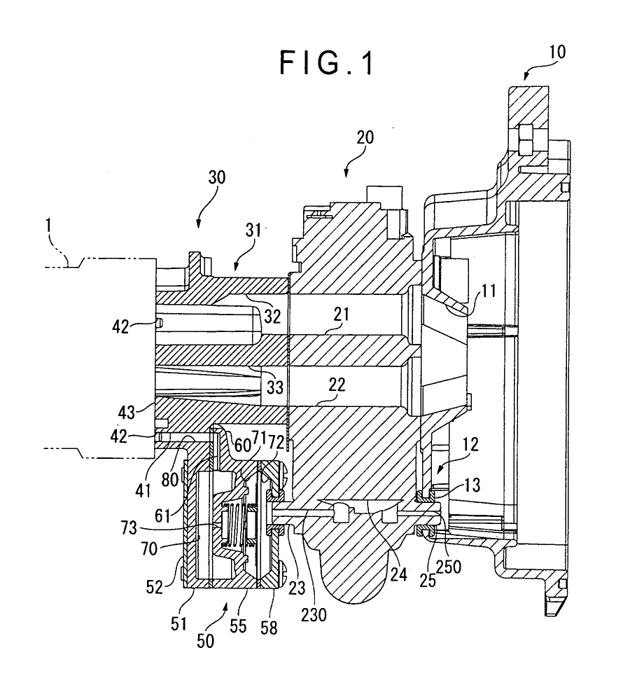

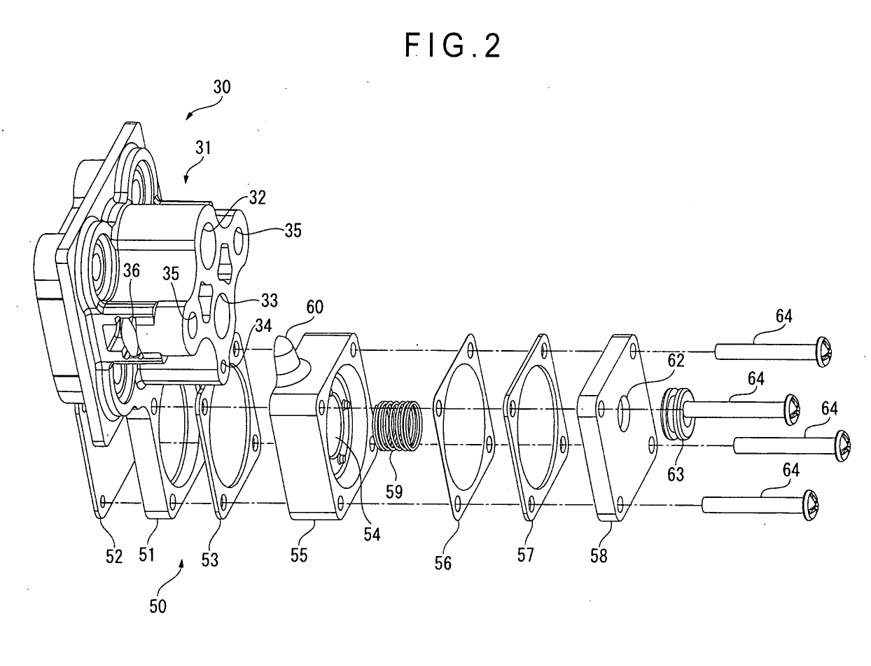

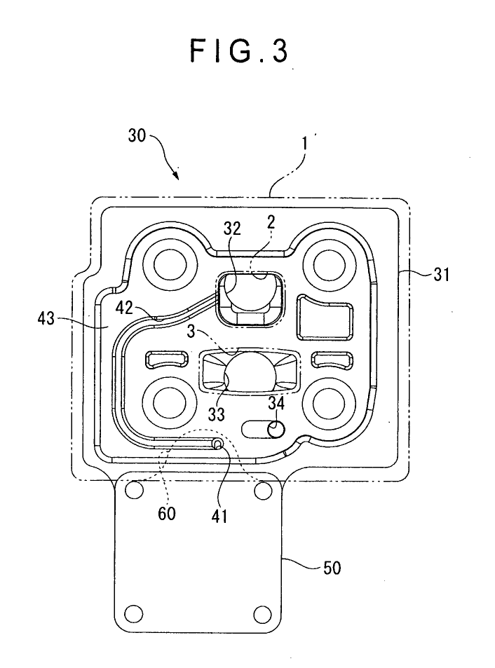

FIG. 1 is a cross sectional side view showing a structure in the vicinity of an insulator 30 according to the first exemplary embodiment. FIG. 2 is an exploded perspective view showing the insulator 30 and FIG. 3 is a rear view showing the insulator 30.

A stratified scavenging two-cycle engine 1, to which the insulator 30 of the invention is mounted, includes an air passage 2 provided close to an intake side and a mixture passage 3 (FIG. 3). Scavenging air and mixture are taken in through the passages 2 and 3 in an intake process. As shown in FIG. 1, a carburetor 20 is mounted to the engine 1 via the insulator 30. An air cleaner 10 including a filter element (not shown) is mounted to the carburetor 20.

The air cleaner 10 is provided with an intake 11. An insertion port 12 is provided on a lower portion of the intake 11. A grommet 13 is fitted to the insertion port 12 and a projection 25 projecting from the carburetor 20 is inserted into the grommet 13. Air for scavenging air and mixture to be delivered into the engine 1 is initially sucked from the intake 11 and delivered into the carburetor 20.

The carburetor 20 includes a carburetor air passage 21 at the upper side, a carburetor mixture passage 22 at the lower side, and a constant-pressure fuel supply mechanism at the bottom. The constant-pressure fuel supply mechanism includes a constant-pressure fuel chamber provided above a first film (not shown), and a carburetor constant-pressure chamber 24 provided below the first film. The carburetor constant-pressure chamber 24 is communicated with the air cleaner 10 (outer air) through a communicating passage 25 provided within the projection 25. The constant-pressure fuel chamber is communicated with the carburetor mixture passage 22. A fuel pump and the like are provided on an upper portion of the constant-pressure fuel chamber by a second film. The second film is vertically moved by pulsatile pressure of a crank chamber transmitted from the engine 1 so as to supply fuel in a fuel tank into the constant-pressure fuel chamber.

While the engine 1 is normally driven, fuel in the constant-pressure fuel chamber is sucked from the constant-pressure fuel chamber to the carburetor mixture passage 22 by negative pressure generated in the carburetor mixture passage 22. A part of the air sucked from the intake 11 is delivered into the carburetor air passage 21 to be further delivered into the insulator 30. The rest of the air is delivered into the carburetor mixture passage 22 and then mixed with the fuel sucked from the constant-pressure fuel chamber so as to be delivered into the insulator 30 as mixture.

The insulator 30 is made of synthetic resin for preventing heat transmission from the engine 1 into the carburetor 20. The insulator 30 includes an insulating section 31 for preventing heat transmission and a frame-shaped acceleration pump attachment 51 integrally provided on a lower side of the insulating section 31 for attaching an acceleration pump 50 according to the exemplary embodiment. In other words, the acceleration pump 50 is disposed in a space between the engine 1 and the carburetor 20 at a lower side of the insulating section 31 by mounting the acceleration pump 50 to the acceleration pump attachment 51 according to the exemplary embodiment. This space is conventionally a dead space in which no components are disposed. Thus, in this exemplary embodiment, the acceleration pump 50 is provided by efficiently using such a dead space, whereby space saving can be achieved.

The insulating section 31 includes an insulator air passage 32 that intercommunicates between the carburetor air passage 21 and the air passage 2 of the engine 1, and an insulator mixture passage 33 that intercommunicates between the carburetor mixture passage 22 and the mixture passage 3 of the engine 1. A pulse-transmitting passage 34 is provided at a lower side of the insulator mixture passage 33. One end of the pulse-transmitting passage 34 is communicated with the crank chamber of the engine 1, and the other end is communicated with the constant-pressure fuel supply mechanism so as to transmit pulsatile pressure in the crank chamber to the constant-pressure fuel supply mechanism. The insulating section 31 is provided with a pair of connecting holes 35. A nut 36 is buried at an inner side of each of the connecting holes 35. A screw (not shown) penetrating the air cleaner 10 and the carburetor 20 is inserted into the connecting holes 35. The screw is screwed with the nut 36, so that the air cleaner 10 and the carburetor 20 are mounted to the insulator 30.

Also, the insulating section 31 is provided with a passage 41 laterally (the right-and-left direction in FIG. 1) penetrating the lower portion of the insulating section 31. A conduit 42 intercommunicating between the insulator air passage 32 and the passage 41 is provided on a connecting surface 43 of the insulating section 31. The connecting surface 43 contacts the engine 1.

As shown in FIG. 2, the acceleration pump 50 includes: a plate 52 attached to a first side of the acceleration pump attachment 51 which is closer to the engine 1; a first case 55 attached to a second side of the acceleration pump 51 which is closer to the carburetor 20; and a second case 58 for covering the first case 55, which are all integrally provided by a screw 64. A gasket 53 is interposed between the acceleration pump attachment 51 and the first case 55. A diaphragm 56 and gasket 57 are interposed between the first case 55 and the second case 58. Further, the first case 55 is provided with a support wall 54. A spring 59 is provided between the support wall 54 and the diaphragm 56.

A space partitioned by the acceleration pump attachment 51, the plate 52, the gasket 53, and the support wall 54 of the first case 55 provides a negative-pressure introducing chamber 70. A space partitioned by the support wall 54 of the first case 55 and the diaphragm 56 provides a negative pressure chamber 71, and a space partitioned by the diaphragm 56, the gasket 57, and the second case 58 provides a pump chamber 72. The negative-pressure introducing chamber 70 and the negative pressure chamber 71 are communicated with each other via a communicating hole 73. In other words, the acceleration pump attachment 51 according to the exemplary embodiment forms the negative-pressure introducing chamber 70 of the acceleration pump 50, i.e., partially forms the acceleration pump 50.

A connecting section 60 is provided on an upper portion of the first case at a position not interfering with the pulse-transmitting passage 34. The connecting section 60 projects upwardly from the first case 55 to be in contact with the vicinity of the passage 41 provided on the lower portion of the insulating section 31. The connecting section 60 is provided with a connecting passage 61 that is conduit-shaped for intercommunicating between the passage 41 of the insulating section 31 and the negative-pressure introducing chamber 70. An insertion port 62 is provided on the second case 58. A grommet 63 is fitted into the insertion port 62 and a projection 23 projecting from the carburetor 20 is inserted into the grommet 63. A pump chamber 72 is communicated with the carburetor constant-pressure chamber 24 through a communicating passage 230 provided within the projection 23.

In the insulating section 31 and the acceleration pump 50, the conduit 42 provided on the connecting surface 43 of the insulating section 31 has a tubular shape by being covered with the engine 1, and the connecting passage 61 provided on the first case of the acceleration pump 50 also has a tubular shape by being covered with a lateral surface of the acceleration pump attachment 51. Thus, the insulator air passage 32 and the negative-pressure introducing chamber 70 are communicated with each other, so that negative pressure in the insulator air passage 32 is introduced into the negative-pressure introducing chamber 70 and further into the negative pressure chamber 71. Consequently, a conventional outer pipe for intercommunicating with the insulator and the acceleration pump is not required, which simplifies a communicating structure and facilitates assembly. In addition, a pressure introducing passage 80 of the invention is provided by the conduit 42, the passage 41, and the connecting passage 61.

The above-described carburetor 20 and the insulator 30 work as described below.

The carburetor air passage 21 is initially closed in conjunction with a throttle valve of the carburetor mixture passage 22 during idling, so that negative pressure is provided in the air passages 2, 21, and 32. Thus, the negative pressure is introduced into the negative-pressure introducing chamber 70 from the insulator air passage 32 through the pressure-introducing passage 80, and the diaphragm 56 is pulled toward the negative pressure chamber 71 against spring force of the spring 59. However, since the throttle valve is opened when the engine 1 is accelerated, the insulator air passage 32 is opened in conjunction with the throttle valve, so that the negative pressure is suddenly lost.

Accordingly, the diaphragm 56 is instantly returned toward the pump chamber 72 by the spring force of the spring 59, and air in the pump chamber 72 is pneumatically sent into the carburetor constant-pressure chamber 24 through the communicating passage 230. Then, the first film partitioning the constant-pressure fuel chamber and the carburetor constant-pressure chamber 24 is pushed up, so that fuel in the constant-pressure fuel chamber is pressurized, which increases an amount of fuel supplied into the carburetor mixture passage 22. Consequently, during sudden acceleration, a supply amount of fuel is temporarily increased by the acceleration pump 50 to smoothly accelerate the engine 1. At this time, the inner diameter of a communicating passage 250 communicated with the carburetor constant-pressure chamber 24 is smaller than the inner diameter of the communicating passage 230 extending from the acceleration pump 50, so that the first film provided above the carburetor constant-pressure chamber 24 can be reliably pushed up by air pneumatically sent from the communicating passage 230.

### Second Exemplary Embodiment

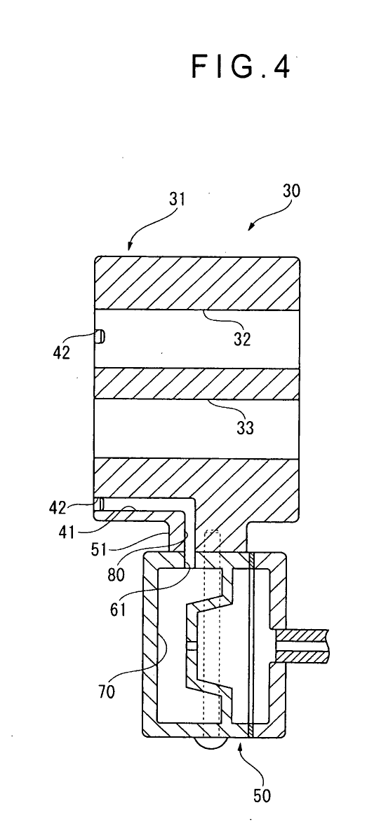

FIG. 4 is a cross sectional side view showing a structure in the vicinity of an insulator 30, a part of which is omitted, according to a second exemplary embodiment of the invention. In the second exemplary embodiment, the same members and functional portions as those of the first exemplary embodiment will be denoted by the same reference numerals, and the description thereof will be omitted or simplified. The same will be applied in a third exemplary embodiment described below.

Unlike the first exemplary embodiment, the acceleration pump attachment 51 does not partially form the acceleration pump 50 according to the second exemplary embodiment.

The acceleration pump attachment 51 projects at the lower portion of the insulating section 31. The acceleration pump 50 is attached to the acceleration pump attachment 51 by a screw or the like. At this time, the passage 41 is provided on the lower portion of the insulating section 31 to penetrate the acceleration pump attachment 51 so as to communicate with the connecting passage 61 provided in the acceleration pump 50.

In this exemplary embodiment, the acceleration pump attachment 51 is also integrated with the insulating section 31, and the acceleration pump 50 is attached to the acceleration pump attachment 51. Accordingly, similarly to the first exemplary embodiment, the acceleration pump 50 is provided on the lower portion of the insulating section 31, and the pressure-introducing passage 80 intercommunicates between the insulator air passage 32 and the negative-pressure introducing chamber 70. Thus, a dedicated space for installing the acceleration pump and an outer pipe is not required so that space saving can be achieved and a communicating structure can be simplified, which means the same advantages can be attained as those in the first exemplary embodiment.

Since the acceleration pump attachment 51 does not partially form the acceleration pump 50 in this exemplary embodiment, a structure of the insulator 30 can be simplified.

### Third Exemplary Embodiment

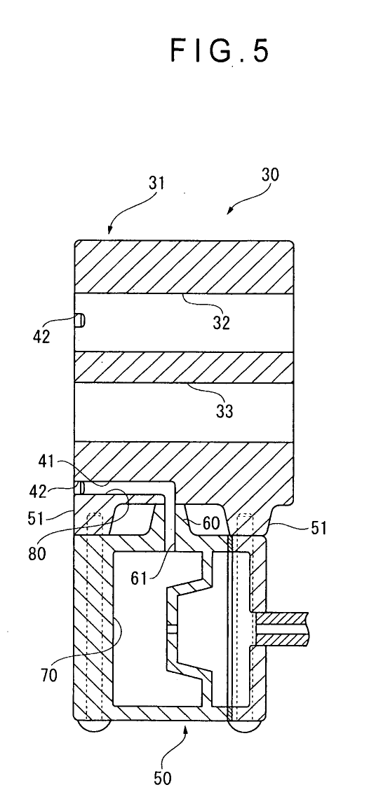

FIG. 5 shows a third exemplary embodiment of the invention.

In the third exemplary embodiment, the acceleration pump attachments 51 are provided on a front lower portion and rear lower portion (both sides in the right-and-left direction in FIG. 5) of the insulating section 31 and do not partially form the acceleration pump 50. Also, the passage 41 provided on the lower portion of the insulating section 31 is not inserted into the acceleration pump attachment 51 and is communicated with the connecting passage 61 within the connecting section 60 provided in the acceleration pump 50.

However, the same advantages can be attained in this exemplary embodiment because of the same arrangements as those of the first and second exemplary embodiments.

Incidentally, the invention is not limited to the above-described embodiments, but includes any modifications, improvements and the like as long as an object of the invention can be achieved.

For example, the conduit 42 of the insulator 30 may be provided on a connecting surface of the insulator section 31 which contacts the carburetor 20 so as to form the pressure-introducing passage 80.

Also, the insulator air passage 32 and the negative-pressure introducing chamber 70 may be communicated with each other through a pipe, not through the pressure-introducing passage 80 including the conduit 42. Since the acceleration pump 50 is disposed in the vicinity of the insulating section 31 even at this time, the length of the pipe can be considerably short, which simplifies a communicating structure.

### INDUSTRIAL APPLICABILITY

The invention is applicable to a portable work machine such as a blower or a brushcutter as an insulator integrated with an acceleration pump provided between a stratified scavenging two-cycle engine and a carburetor.

1. An insulator, comprising: an insulating section that is provided between an engine and a carburetor and includes an insulator air passage and an insulator mixture passage; and
an acceleration pump attachment to which an acceleration pump is attached, the acceleration pump attachment being integrated with the insulating section.

2. The insulator according to claim 1, wherein
a conduit for a pressure-introducing passage that intercommunicates between a negative-pressure introducing chamber of the acceleration pump attached to the acceleration pump attachment and an insulator air passage of the insulating section is provided on a connecting surface of the insulating section, the connecting surface being in contact with the engine or the carburetor.
